(19) United States
(12) Patent Application Publication
(10) Pub. No.: US 2006/0043782 A1
(43) Pub. Date: Mar. 2, 2006

(54) Vehicle wheel and overlay assembly

(76) Inventor: Garry Van Houten, Middleville, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 10/932,903

(22) Filed: Sep. 2, 2004

(51) Int. Cl. B60B 7/00

(52) U.S. Cl. 301/37.43

(57) ABSTRACT

A vehicle wheel and overlay assembly. The assembly includes a wheel having a rim flange that terminates in a flange lip having an outboard surface and a radially outermost edge. At least one circumferential indentation or groove is formed on the outboard surface of the flange lip to intercept and contain excess adhesive that may radially flow toward the outer edges of the assembly necessitating a costly clean up. An overlay is attached to the wheel outboard surface. The overlay radially extends outward and terminates in a rim flange. This rim flange includes a radially outermost lip, which is aligned with the outermost edge of the wheel flange lip within a predetermined circumferential margin such that, the rim flange of the overlay covers at least a portion of the wheel flange lip without wrapping around the periphery of the wheel. This configuration gives a visible impression that this is a one-piece wheel, and the overlay is not a separately attached component. The circumferential indentation or groove creates cavity on the outboard surface of the flange lip and appreciably reduce surface contact between the overlay and the wheel, resulting in reduced friction between the surfaces. The reduced friction helps minimize the squeaking or noise from the overlay rubbing against the wheel.

### CROSS REFERENCE TO RELATED APPLICATION

Not applicable.

### FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to vehicle wheels that are equipped with an attached chromium-plated wheel cover, cladding or overlay. The metal plated overlay's bond strength permits the overlay to be shaped and contoured on to the shape of the wheel, so as to maximize aesthetic effects.

2. Description of the Related Art

Decorative wheel trim in the form of chromium plated wheel covers or claddings adhesively attached to steel or aluminum wheels have been emphasized for providing enhancing aesthetic features of automotive wheels. In addition, to improving the appearance of unadorned standard steel wheels, significant styling flexibility is available to the stylist to create unique aesthetic characteristics for selective vehicles. Below, numerous structural approaches for combining overlays with steel and/or cast wheels, which can be divided into three basic approaches for solving defined problems.

In the first group, U.S. Pat. No. 5,636,906 to Chase, owned by the assignee hereof, presents a metal-plated plastic overlay adhesively secured to the outboard surface of the wheel disk. Although, the overlay provides a pleasing effect by covering most of the wheel's outboard surface, it does not radially extend outward to cover the flange lip of the rim flange of the wheel.

U.S. Pat. No. 5,368,370 to Beam discloses a permanently secured chrome-plated stainless steel cladding or cover having an outer peripheral edge that is forced into engagement within a groove or catch formed on the outboard surface of the rim flange of the wheel. This engagement locates and locks the wheel cover in place on the outboard surface of the wheel while the adhesive cures to permanently secure the cover to the wheel. As with the Chase prior art, the wheel cover covers most of the wheel's outboard surface of the wheel but it does not adequately cover the flange lip of the rim flange of the wheel. Likewise, as taught in Beam, Maloney et al., U.S. Pat. No. 5,435,631 presents a wheel cover retention system, which includes a groove formed in the rim flange of a wheel to permanently secure the cover to the outboard surface of the wheel. Again, as in Beam, this wheel cover radially extends outward, but fails to adequately cover the flange lip of the rim flange of the wheel.

Each of these prior art configurations can result in a significant cost increase if the adhesive, due to improper manufacturing control, squeezes out from underneath the cover to collect at the interface of the cover and wheel rim flange. This adhesive must be manually removed before the wheel/cladding assembly is shipped to the vehicle manufacturer for assembly to a vehicle. Further, since the cladding does not cover the lip of the rim flange in each of these applications there is a visual perception that the wheel is smaller than actual size because of a park line circumferentially surrounding the bright chrome finish of the cladding.

U.S. Pat. No. 5,842,750 to Murray et al. discloses a urethane foam cover molded in-situ and permanently secured to the outboard surface of a wheel, wherein the urethane foam radially extends outwardly from fastener holes in the disk of the wheel to cover at least a portion of an outboard flange edge of the wheel. Murray et al. thereby eliminates the prior art requirement of trimming offal formed at an outboard flange edge of the wheel, as well as avoids the visual perception of the circumferential dark line surrounding the bright chrome finish cladding.

Unfortunately, there are several drawbacks in using a molded in-situ urethane cover for a wheel. Since the urethane material is directly molded onto the outboard surface of the wheel, the urethane material on the outboard surface of the wheel will have a tendency to break down in certain areas of the wheel under extremely high temperatures. Generally, under certain road conditions, the wheel hub area of the wheel disk experiences such extreme temperatures. Further, it is understood by those skilled in the art that one of the reasons for spacing a plastic wheel cover from the outboard surface of a wheel is to avoid the deleterious effects of heat generated in the disk of the wheel by the brake system. Such high temperatures in the disk of a wheel can otherwise distort or melt the plastic wheel cover. The high temperatures in the disk of a wheel can also delaminate any surface treatment, i.e., paint, etc., applied thereto. Those skilled in the art will also recognize that, when a cavity between the outboard surface of the wheel and the wheel cover is completely filled, a localized inclusion of the fill affects the wheel weight, balance, and the fuel economy. Finally, from the teachings of Murray et al., it is understood that a steady supply of wheels must be available to the manufacturer for molding of the wheel cover to the wheel. This requirement is somewhat complicated, expensive, and may be impractical for just in time manufacturing program. Finally, and most significantly, the urethane overlay taught by Murray et al. dictates a variable thickness that is wedge-shaped in cross-section at the outboard rim flange edge of the wheel. Accordingly, the radially outermost portion of the plastic urethane overlay will be extremely thin. This thin layer of urethane molding along the outboard flange edge of the wheel is highly susceptible to chipping, and may result in an aesthetically unacceptable surface appearance.

It is evident from each of the above references that, although each overlay covers a substantial portion of the outboard surface of the wheel, none of the overlays reliably covers the flange lip of the rim flange of the wheel. Accordingly, the exposed flange lip of the rim flange can get chipped by flying objects, and thereby, exposing the bare metal of the wheel to road salt, mud, water, and etc. Additionally, the stainless steel overlays of Beam and Murray et al. can cause galvanic action along the interface where the overlay engages into the groove of rim flange of the hot roll steel wheel resulting in deposits of corrosion, commonly known as “red rust.” Further, the exposed flange lip of the rim flange of the wheel circumscribing the periphery of the overlay manifests that this is a cladded wheel and tends to make the wheel look smaller than its actual size. This exposure of the flange lip of the rim flange therefore completely fails to meet the objective of the cladding providing the visual impression to an observer that this is a chrome plated wheel. The objective is to provide a visible impression to an observer that, this is a one-piece wheel, wherein the entire visible outboard surface of the overlay appears to be the outboard surface of the wheel and not a separately attached component of the wheel and overlay assembly. Wheel and wheel cover tolerances may stack up to reveal a noticeable eccentricity between the wheel cover and the wheel. For instance, where the wheel cover may adequately cover one arcuate sector of the wheel's outboard surface at the radial outer periphery of the wheel, an opposite arcuate sector of the outboard surface may be insufficiently covered. This situation will tend to reveal an obvious non-symmetrical and aesthetically unacceptable appearance (not chrome-plated) of the wheel and overlay assembly. Additionally, the exposed flange lip of the rim flange of the wheel along the radial outer periphery of the rim flange of the overlay also will tend to make the wheel look smaller and less robust to the consumer. In contrast to these references of the first group of prior art, the references of the second group of prior art below address wheel trim that extend beyond the periphery of the flange lip of the rim flange of the wheel in order to overcome some of the above noted short comings of the prior art.

For example, Reppert, U.S. Pat. No. 4,275,931, and Bowling, U.S. Pat. No. 4,348,061, both teach a wheel trim ring that snaps onto the rim flange of the wheel to extend beyond the flange lip of the rim flange of the wheel. Similarly, U.S. Pat. Re. No. 35,497 to Carter III teaches a wheel cover which radially extends beyond an outer peripheral edge of the rim flange of the wheel. Additionally, Polka, U.S. Pat. No. 5,358,313 teaches an adjustable wheel liner for truck wheels wherein the wheel cover extends well over the flange lip of the rim flange of the wheel.

Todd, U.S. Pat. No. 5,143,426 teaches a vehicle wheel construction that eliminates the use of adhesive to secure the wheel cover to the wheel. Todd discloses that the wheel cover assembly has a molded polystyrene base applied directly to an outboard surface of a wheel. An ornamental thermoplastic fascia coat covers the molded polystyrene base. The fascia coat is mechanically locked by using a mechanical interface with the periphery of the vent openings in the wheel. Although, Todd discloses that a peripheral edge of the fascia extends to an edge of the wheel, it fails to clearly disclose whether it actually covers the flange lip of the rim flange of the wheel.

Hodge et al., U.S. Pat. No. 5,346,288 discloses that an outer peripheral portion of the wheel cover overlies an outwardly turned flange portion of the wheel, and is positioned in lateral proximity thereto. As in Todd, Hodge et al. does not clearly disclose whether the wheel cover overlaps the flange lip of the rim flange of the wheel. It appears, though not clear, that the overlapping relationships between the wheel cover and the flange lip of the wheel appear to be nearly co-diametrical. Since there is no clear disclosure to the contrary, it is a reasonable presumption by a person skilled in the art that the cover of both Todd and Hodge et al. can radially extend beyond the radially extreme edge of the wheel due to tolerance variations in both the wheel outside diameter and the wheel cover outside diameter.

An alternative approach to solving the problems of the references of the above described prior art involves not only extending the overlay beyond the radial outer periphery of the rim flange of the wheel, but also actually wrapping the overlay around the flange lip of the rim flange of the wheel. For example, Beith, U.S. Pat. No. 3,726,566 and Kemmerer et al., U.S. Pat. No. 6,270,167 B1, both teach that the edge of the wheel cover is formed to grip over and around the edge of the terminal flange of the wheel, to aid in attaching the wheel cover to the wheel. In addition, in Kemmerer et al., the inner surface of the outboard tire-bead seat-retaining flange of the wheel includes at least one annular groove. The wheel cover is permanently secured to the wheel disk by an adhesive/sealant. In particular, the adhesive is disposed in the annular groove to secure the outer peripheral end of the wheel cover to the outer peripheral end of the wheel disk, and to provide a seal to prevent water, mud, road salt and other debris from entering between the outer end of the wheel cover and the outer end of the wheel disk. Heck et al., U.S. Pat. No. 5,595,423 and Eikhoff, U.S. Pat. No. 5,829,843 disclose similar teachings. Heck et al. discloses an adhesively secured stainless steel overlay that covers at least a portion of the outboard facing disk of the wheel and the entire portion of the outer peripheral flange lip of the outboard tire-bead seat-retaining flange or rim flange of the wheel. An adhesive is applied on the outboard face of the wheel disk in a predetermined pattern, so that when the wheel cover is attached to the wheel disk, the adhesive spreads over a substantial area of the outboard surface of the disk. Since the adhesive covers almost the entire portion of the interface between the wheel cover and the disk, it effectively prevents water, mud, salt, and other debris from entering the space between the wheel cover and the disk of the wheel. At the outer peripheral edge of the rim flange of the wheel facing the tire, there is a smoothly rounded outer peripheral end and a circumferential, radially outwardly facing groove. The groove is formed on the inboard side of the tire-bead retaining flange or rim flange of the wheel. The outer peripheral end portion of the wheel cover is assembled to the smoothly rounded outer peripheral end of the wheel and terminates in the groove adjacent to the tire. However, this invention, like the previous prior art, has several problems.

For example, these type of wheel cover assemblies are not without their problems, the assembly of the stainless steel wheel cover in Heck et al. requires an over bend to accommodate the natural spring-back of the radial end. This over bend causes a frictional engagement between the smoothly rounded outer peripheral end of the wheel and the outer peripheral edge of the wheel cover resulting in the potential removal of protective coatings that may have been applied to the outboard surface of the wheel. Removal of protective coatings exposes the wheel material in direct contact with the stainless steel wheel cover. This contact between the wheel and the stainless steel wheel cover can initiate galvanic action along where the cover meets the exposed rim flange of the wheel. This reference shares additional problems with the second group of prior art, and are delineated below.

Although, the references of the second group of prior art address some of the problems associated with the references of the first group of prior art, they nonetheless fail to identify and address several additional problems, which still exist. Tire servicing, radial load deflections during operation, and “run flat” conditions are all situations in which permanent damage to the overlay or tire can occur. During the installation and removal of the tire, service equipment that locates on the extreme periphery of the rim flange of the wheel will damage a wheel cover that wraps around the flange lip of the rim flange of the wheel. This will occur where the outermost diameter of the wheel cover is greater than the outermost diameter of the wheel, and could occur if the peripheral flange of the wheel cover is not located net against the flange lip of the rim flange of the wheel. Likewise, where the outermost diameter of the wheel cover is greater than that of the wheel, it is likely that many wheel covers from the prior art references would be damaged upon either installation or removal of wheel balance weights. Additionally, such wheel covers are more likely to be cracked and/or chipped when a wheel hits a curb or a pothole. Similar damages may occur as a result of material handling in the production process when outer diameter of assembled wheels collide into one another such as it happens on a gravity feed conveyor. In addition, when a wheel and overlay assembly rolls on a surface without a tire, the surface treatment (chrome plating) of the wheel cover will chip since the cover wraps around the outside diameter of the wheel.

Further, a wheel and overlay assembly, wherein the wheel cover wraps around the rim flange, appears to look larger relative to the width of the black rubber of a tire. This appearance of the wheel and overlay assembly adversely affects the overall aesthetic of the vehicle. If the wheel cover wraps around a rim flange, the resultant outer diameter of the assembly becomes larger than the outer diameter of the wheel itself. The only way to solve this problem is to reduce the outer diameter of the wheel before the overlay is attached to it, so that when the overlay wraps around the rim flange of a reduced diameter wheel, the resulting assembly has the same outer diameter as the original design intent. Such solution is not tolerable since it affects the structural integrity of the wheel as well as significantly increases the cost of producing the wheel only.

It is a well-known fact in the art that, during vehicle operation, radial loads deflect and distort the rim flange area of a wheel; as a result, any structure that wraps around the rim flange of the wheel will accordingly deflect and distort. The chromium plated surface layer of such deflected and distorted wheel cover will be subject to excessive stresses, which could lead to spider cracks in the chrome plated layer. Instances, where the overlay's peripheral edge lies or engages in a groove in the rim flange of the wheel, repeated deflections and distortions could dislodge or unseat the overlay's peripheral edge from the groove, and eventually separate it from the wheel. Since the tire sits very close to such grooves, such unseated edge of an overlay may cut into the tire, causing a safety related problem. This situation is more likely to occur under “run flat” conditions. When a vehicle runs for a short distance on flat tire, the tire sidewalls outwardly distort over the rim flange of the wheel, and spin relative to the wheel. The sharp peripheral edge of an overlay, which wraps around the rim flange of a wheel, may tear into the rubber tire causing expensive damage.

One significant advantage encountered with wrapping the wheel cover around the rim flange of the wheels is that the well known problem of adhesive squeezing out from between the cover and wheel assembly is completely eliminated. This is the published U.S. patent application Ser. No. 09/775,425, owned by the assignee hereof. This invention discloses a wheel and overlay assembly, which includes an overlay that is permanently secured to the outboard surface of a wheel, where the overlay radially extends in an outward direction to substantially cover the entire outboard surface of the wheel, without wrapping around the periphery of the wheel. The wheel and overlay assembly includes a wheel having a rim flange that terminates in a flange lip having a radially outermost edge. The overlay radially terminates in a peripheral flange that has a peripheral lip with a radially outermost edge that is aligned with the outermost edge of the wheel flange within a predetermined circumferential margin so that the overlay covers a majority portion of the wheels rim flange terminating within a predetermined margin of the radially outermost edge of the wheel. This arrangement creates a visible impression that the outboard surface of the overlay is actually the outboard surface of the wheel, and not a separately attached component of the wheel and overlay assembly.

Unlike previous references, this invention accomplishes the aforementioned visible impression without wrapping the overlay's peripheral flange portion around the flange lip of the rim flange of the wheel thereby eliminating the detrimental problems associated with wrap around wheel claddings. This invention also addresses and actually solves the disadvantages of the other prior art references in which the overlay extends up to, but does not adequately cover the flange lip of the rim flange of the wheel because by keeping the edge of the cover within a predetermined margin of the edge of the wheel the perceived detrimental aesthetic effects of a wheel/cladding assembly being larger or smaller than what it actually is, is not realized.

While the above-mentioned reference has distinct advantages over previous wheel and overlay assembly systems, the possibility of adhesive squeeze out due to manufacturing variances again comes into play. If the robotic application of the adhesive at assembly cannot be carefully controlled, the adhesive will likely flow beyond the outer edges of the wheel and overlay assembly and require costly clean-up operations. Eventually, tolerance variations in the application of the adhesive may result in squeeze out along the outer periphery of the wheel and overlay assembly necessitating a costly clean up procedure. This squeeze out of adhesive, if not properly cleaned up, is aesthetically unacceptable to the car assembly client.

Since the aesthetic objective is to provide a wheel/cladding assembly that is perceived to be an actual chrome plated wheel, any amount of squeeze out of adhesive along the mating surfaces of the cover and wheel is unacceptable. In addition, none of the references has addressed the issue of friction between the outer peripheral edge of the wheel cover and the flange lip of the rim flange of the wheel. If no attempts are made to control this friction between the wheel cover and the wheel, during normal operation of a vehicle, excessive squeak or noise will emit from the wheel and overlay assembly creating an audible sound pollution around the vehicle.

Accordingly, what is needed is a wheel and overlay assembly, in which an overlay covers the entire outboard surface of the wheel including the flange lip of the rim flange of the wheel, without wrapping around the flange lip of the rim flange of the wheel to give an aesthetic perception to an observer that the cladding/wheel assembly is a chrome plated wheel. The overlay in such a wheel and overlay assembly is preferably net located against the flange lip of the rim flange of the wheel, and adhesively secured to the outboard surface of the wheel with appropriate assurance that no squeeze out of adhesive can occur. By eliminating such squeeze out of adhesive, this measure will simultaneously help achieve an aesthetically pleasing look, namely, the visible impression that, the outboard surface of the overlay is actually the outboard surface of the wheel, and not a separately attached component of the entire assembly.

### BRIEF SUMMARY OF THE INVENTION

According to the present invention, there is provided a wheel and overlay assembly in which, an overlay is adhesively secured to the outboard surface of a wheel. The overlay is radially positioned within a predetermined margin of the outermost edge of the wheel to cover the entire outboard face of the wheel. The overlay is radially extended outward to cover the flange lip of the rim flange of the wheel within a predetermined margin without actually wrapping around the flange lip of the rim flange of the wheel. The wheel of the present invention includes an outboard surface defined by a disk, and a rim circumscribing about the disk. The rim's radial outer periphery (or the disk's outer periphery in the case of a full-face wheel) is defined by a rim flange having a flange lip. Unlike the traditional rim flange of a wheel, in which the rim flange radially extends in the generally axially outboard direction and terminates in an outwardly extended flange lip, the rim flange in the preferred embodiment of the present invention radially extends in an outward direction without having any axial outboard extension thereto. The radially outwardly extended rim flange terminates in a flange lip or edge, which continues from the rim flange in a radially outward direction having a radially outermost edge. The outboard surface of the rim flange of the wheel includes at least one circumferential indentation or groove. Additionally, the present invention includes an overlay that covers the entire outboard surface of the wheel within a predetermined margin including the flange lip of the rim flange of the wheel. The overlay has a web portion with an outboard surface, and an integral peripheral flange portion circumscribing the web portion. Further, the peripheral flange portion of the overlay terminates in a rim flange having a radially outermost lip or peripheral edge. The rim flange of the overlay has an inboard surface, which is near to the radially outermost edge of the flange lip of the rim flange of the wheel. The radially outermost lip or peripheral edge of the rim flange of the overlay is circumferentially aligned within a predetermined tolerance variation of the radial outer periphery of the rim flange of the wheel. This circumferential alignment of the overlay insures that the rim flange of the overlay covers substantially the entire flange lip of the rim flange of the wheel without wrapping around the edge of the wheel. This configuration gives a visible impression to an observer of the vehicle or the wheel assembly that the entire outboard surface of the overlay is actually the outboard surface of the wheel. An aspect of the present invention is that at least a portion of the overlay is spaced away from the outboard surface of the wheel to define a gap therebetween. An adequate quantity of adhesive is selectively deposited between the overlay and the wheel in a predetermined pattern to insure that adequate adhesive is present to adhere the cladding to the wheel but does not squeeze out along the outer periphery of the wheel and overlay assembly at the interface of the claddings and the wheel. The presence of the circumferential indentation(s) or groove(s) on the outboard surface of the flange lip of the wheel is to provide an overflow cavity or depression so as to capture and contain such excess adhesive eliminating the need for a costly clean up. This would also create a film of adhesive around the circumferential indentation or groove between the overlay and the wheel. Further, the cavity, formed by such circumferential indentation or groove on the outboard surface of the flange lip of the wheel, results in a reduction of surface area contact between the flange lip of the wheel and the rim flange of the overlay. Together, this reduced surface contact between the wheel and the overlay, and the film of adhesive around the circumferential indentation or groove of the flange lip of the rim flange of the wheel reduces the likelihood of movement of the overlay with respect to the wheel, resulting in a reduced likelihood of noise generation due to frictional movement between the overlay and wheel.

Accordingly, it is an object of the present invention to offer a wheel and overlay assembly in which, the costly clean up of squeeze out of excess adhesive along the outer periphery of the assembly is eliminated.

It is another object of the present invention to provide a depression or cavity into which excess adhesive can flow in case of tolerance variations in the process of robotically depositing the adhesive onto the cladding or wheel.

It is further an object of the present invention that in the event the adhesive does radially flow in an outward direction, the excess adhesive is accumulated in the peripheral grooves machined into the wheel.

It is yet another object of the present invention to receive the intercepted excess adhesive by providing circumferential indentation or groove on the outboard surface of the flange lip of the wheel rim flange. Such circumferential indentation or groove would act as a reservoir to contain the flow of excess adhesive and thereby prevent squeeze out along the outer periphery of the assembly. It is a further object of the present invention not to deposit adhesive in the circumferential indentation or groove to attach the overlay to the wheel, rather, to utilize the grooves or indentation as a reservoir for excess adhesive to flow into and prevent this excess adhesive from squeezing out along the outer periphery of the assembly.

Another object of the present invention is to allow the accumulated adhesive in the circumferential indentation or groove to create a film of adhesive between the flange lip of the overlay and the flange lip of the wheel to adhere the wheel cladding to the wheel.

It is still an object of the present invention to reduce squeaking or noise as a result of excessive frictional contact between the overlay and the wheel resulting in the overlay rubbing against the flange lip of the wheel during normal operation of the vehicle.

It is also an object of the present invention to provide reduced surface contact between the flange lip of the overlay and the flange lip of the wheel to minimize squeaking or noise due to the frictional contact between the overlay and the wheel.

It is yet another object and advantage of the present invention to take advantage of the circumferential indentation or groove on the outboard surface of the flange lip of the rim flange of the wheel to create such reduced surface contact between the overlay and the wheel.

The other objects and advantages of the present invention are that since, the overlay does not wrap around the flange lip of the rim flange of the wheel, the overlay will protect the flange lip of the wheel from chipping due to objects hitting the flange lip of the wheel. The overlay is not vulnerable to damages occurring from “run flat” conditions, servicing of the tires, and removing and attaching of wheel balance weights. There are no sharp edges anywhere near the tire, which could damage the rubber of the tire. Also, the overlay will not make the wheel and overlay assembly look larger than its actual size.

Finally, it is an object of the present invention to combine all previously mentioned objects and advantages to offer a consumer a wheel and overlay assembly, which creates an aesthetically pleasing impression of a cladding/wheel assembly made of a single chrome plated wheel, whereby the entire visible outboard surface of the overlay appears to be the entire outboard surface of the wheel, and not a separately attached component of the assembly.

Other objects and advantages of the present invention will be more apparent after a reading of the following detailed description is taken in conjunction with the drawings provided.

### BRIEF DESCRIPTION OF THE SEVERAL VIEWS OF DRAWINGS

FIG. 1 illustrates an exploded perspective view of a vehicle wheel assembly including an overlay and a tire mounted to a wheel;

FIG. 2 illustrates a side view of the vehicle wheel assembly of the present invention;

FIG. 3 illustrates a cross-sectional view of the vehicle wheel assembly of FIG. 2 taken along line 3-3 thereof;

FIG. 4 illustrates a cross-sectional view of the vehicle wheel assembly with a traditional rim flange and flange lip on the wheel extending in an axially outboard direction incorporating the invention.

FIG. 5 illustrates a cross-sectional view of the rim flange area of a “Euro” style flange with a lower rim flange height and an overlay that terminates within a predetermined margin from the radially outer periphery of the wheel and locates net by abutting on the flange lip of the rim flange;

FIG. 6 illustrates a cross-sectional view of the rim flange area of a “Euro” style flange, similar to FIG. 5, wherein the overlay is net located on the flange lip of the rim flange of the wheel and an offset integrally extends from an inboard face of the overlay;

FIG. 7 illustrates a cross-sectional view of the peripheral outboard area of the rim area of a wheel similar to a “Euro” style wheel wherein an axially outboard extending portion of the rim flange of the wheel has been eliminated completely and the overlay is bonded to an outboard face of the remaining portion of the rim of the wheel;

FIG. 8 illustrates a cross-sectional view of the rim flange area of a wheel wherein an axially outboard extending portion of a standard rim flange of a wheel has been replaced by an overlay shaped in the form of an axially extending rim flange to which a wheel weight may be attached, and wherein the wheel cover is not located net against the wheel;

FIG. 8A illustrates a cross-sectional view of a rim flange area of a wheel wherein an axially outboard extending portion of a standard rim flange of a wheel has been replaced by an overlay shaped in the form of an axially extending rim flange to which a wheel weight maybe attached and wherein the wheel cover is not located net against the wheel;

FIG. 9 illustrates a cross-sectional view of the rim flange area of a wheel wherein an axially outboard extending portion of the rim flange of the wheel has been replaced by an overlay shaped in the form of a wheel flange lip to accommodate a wheel weight;

FIG. 10A illustrates a cross-sectional view of the rim flange area of a generic wheel and overlay assembly wherein a maximum circumferential margin is shown; and

FIG. 10B illustrates a cross-sectional view of a rim flange area of a generic wheel and overlay assembly wherein a minimum circumferential margin is shown.

### DETAILED DESCRIPTION OF THE INVENTION

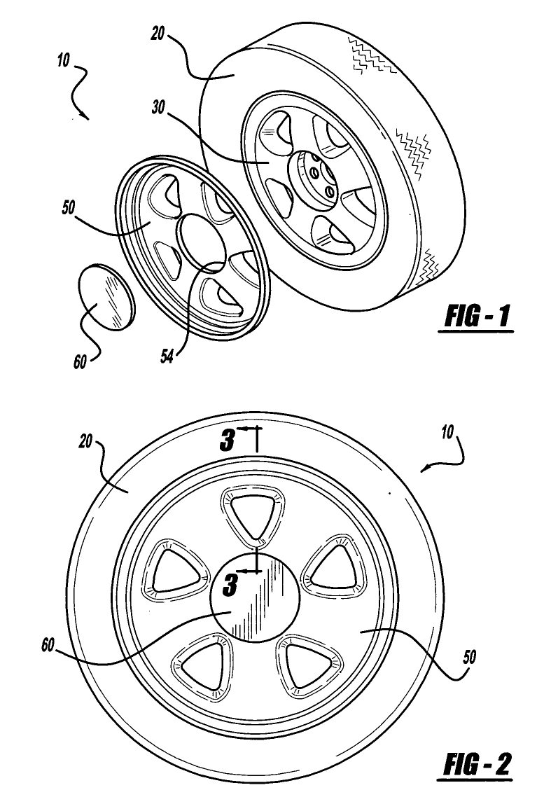

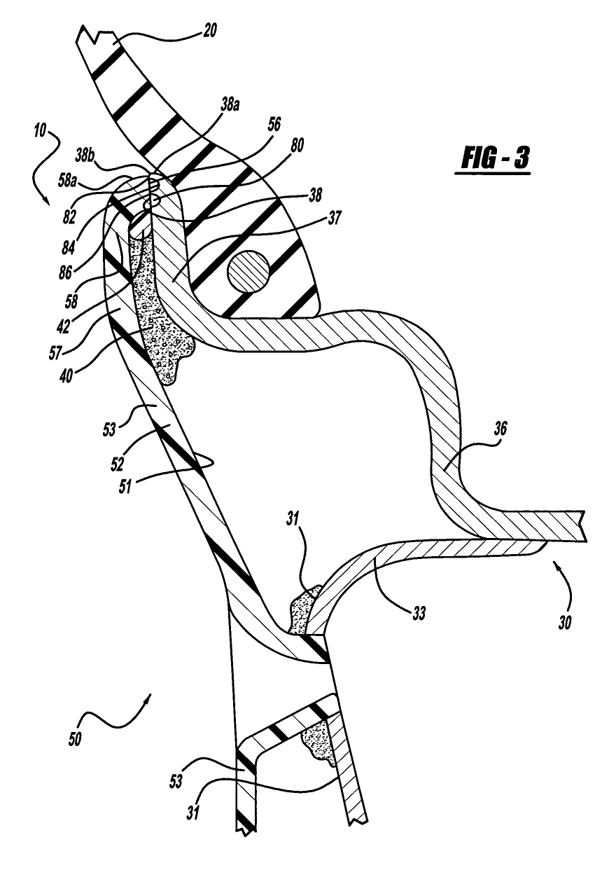

Referring now to the drawings and with particular attention to FIGS. 1-3, there is illustrated in FIG. 1 an exploded perspective view of a vehicle cladded wheel assembly, indicated generally at 10, wherein the wheel is constructed according to any one of the following well known wheel constructions: 1) a “bead seat attached wheel,” such as shown in FIG. 4 of U.S. Pat. No. 5,188,429 to Heck et al.; 2) a “well attached wheel,” such as shown in FIG. 3 of U.S. Pat. No. 5,188,429 to Heck et al.; 3) a one-piece cast or forged alloy wheel, such as shown in U.S. Pat. No. 5,636,906 to Chase; 4) a two-piece welded steel wheel, offset (drop center rim) as shown in FIG. 2 of U.S. Pat. No. 5,597,213 to Chase; 5) a partial rim and a full face, such as shown in FIG. 2 of U.S. Pat. No. 5,595,423 to Heck et al.; or 6) a “Euro” flange construction such as shown in U.S. Pat. No. 4,438,979 to Renz et al. Because of these various prior art wheel constructions, the Society of Automotive Engineers engineering nomenclature as published in SAE J1982 DEC91 and SAE J1986 FEB93 is adapted in the following description of the preferred embodiment, which follows.

Referring to the FIGS. 1 through 3 generally, according to the present invention there is provided a full or partial vehicle wheel cover or overlay 50 that is permanently secured to a vehicle wheel 30 using a semi-rigid polyurethane foam adhesive 40 as set forth in U.S. Pat. Nos. 5,636,906, 5,564,791, and 5,597,213, to Chase, U.S. patent application Ser. No. 09/775,425, entitled “Vehicle Wheel and Overlay Assembly” by Chase, all owned by the common assignee hereof; and Heck et al., U.S. Pat. No. 5,595,423, all of which are incorporated by reference herein. According to the present invention the overlay 50 has been brought radially outwards within a predetermined margin to cover a flange lip 38 of a rim flange 37 of the wheel 30 without extending radially beyond a radially outermost edge 38a of the rim flange 37 of the wheel 30 and without wrapping around the flange lip 38 of the wheel. Unlike the traditional rim flange of a wheel, in which the rim flange radially extends in the generally axially outboard direction and terminates in an outwardly extended flange lip, the rim flange 37 in the preferred embodiment of the present invention radially extends in an outward direction without having any axial outboard extension thereto as will be illustrated hereinafter. The radially outwardly extended rim flange of the wheel 37 terminates in the flange lip 38, which continues from the rim flange 37 in a radially outward direction having the radially outermost edge 38a. Furthermore, all of the embodiments apply equally well to a one-piece cast or forged alloy wheel, a bead seat attached wheel, a drop well-attached wheel, a wheel construction including a partial rim and full face wheel disk, among others; all of such prior art wheels are incorporated by reference herein.

FIG. 1 illustrates an exploded view of the vehicle cladded wheel assembly 10 that is constructed in accordance with the present invention. The present invention includes a wheel hub cover 60 that snaps into a central aperture 54 of the overlay 50 that in turn attaches to the wheel 30 upon which a tire 20 is mounted. As illustrated in FIG. 2, the vehicle cladded wheel assembly 10 appears to include only the wheel hub cover 60, the overlay 50, and the tire 20, when viewed from the outboard side. This provides the consumer with the visible impression that the overlay 50 actually is an actual chrome plated wheel (not visible), and not a separate attachment.

Referring to the preferred embodiment of FIG. 3, the vehicle cladded wheel assembly is illustrated including the tire 20 mounted to a rim 36 of the wheel 30. The rim 36 is circumscribed about a disk 33 and has a rim flange 37 circumscribed about the rim 36 extending in a generally radially outward direction.

A person skilled in the art will recognize that these well defined distinctions become somewhat obscured where the wheel assembly is of the “full face” type, with the disk 33 extending integrally into the area of the rim to define a rim flange. However, the wheel illustrated in the figure is a two-piece welded construction (drop center rim) of the disk 33 welded to a rim. The rim flange 37 radially extends in the generally outward direction and, as shown in FIG. 3, terminates in the flange lip 38. The flange lip 38 has a radially outermost surface 38b defined by the radially outermost edge 38a. Finally, the wheel 30 has an outboard surface 31 consisting of the outboard portions of the disk 33, rim flange 37, and the flange lip 38, to which the overlay 50 is attached.

The overlay 50 includes a rim flange 58 having a radially outermost lip or peripheral edge 58a with an inboard surface 56 that is net located against the flange lip 38 of the wheel 30. An adhesive or sealant bead 42 and a foam adhesive 40 take up any axial tolerance variations between an inboard surface 51 of the overlay and the outboard surface 31 of the wheel. The adhesive 40 is preferably a selectively deposited adhesive but can also be foam adhesive as described above. A portion of the overlay 50 is thereby kept spaced away from the wheel 30 which accommodates the sealant bead or adhesive 42, and the overlay 50 is permanently attached to the wheel 30 using the foam adhesive 40 located between the outboard surface 31 of the wheel 30 and the inboard surface 51 of the overlay 50. The sealant or adhesive bead 42 may be composed of a quick-cure, moisture-cure, or an ultraviolet-cure urethane, silicone, or the like. The overlay 50 is made of a thin gauge plastic panel and includes a peripheral flange portion 57 circumscribed integrally about a web portion 53.

The peripheral flange portion 57 terminates in a radially outer direction in the rim flange 58 with a radially outermost lip or peripheral edge 58a. In accordance with the present invention, generally the radially outermost lip or peripheral edge 58a of the overlay 50 is designed to not extend under any tolerance stack-up condition beyond the radially outermost edge 38a of the wheel 30, as also illustrated in the side view of the vehicle cladded wheel assembly 10 of FIG. 2. Note that the rim flange 58 of the overlay 50 is located net to the flange lip 38 of the wheel 30, such that the radially outermost lip or peripheral edge 58a covers a major portion of the flange lip 38 of the wheel but does not extend radially therebeyond. Accordingly, the overall outside diameter of the overlay 50 does not exceed the overall outside diameter of the wheel 30 such that the overall diameters may at most be exactly co-diametrical, but preferably, there should be a circumferential margin between the overall diameter of the overlay 50 and the overall diameter of the wheel 30. In other words, the radially outermost lip or peripheral edge 58a of the overlay 50 is preferably aligned or slightly less than the radially outermost edge 38a of the wheel 30 such that there is a slight radial offset therebetween. This offset or circumferential margin can encompass any dimension so long as the radially outermost lip or peripheral edge 58a of the rim flange 58 of the overlay covers a major portion of the flange lip 38 of the wheel. Preferably, the circumferential margin is 1.2 to 1.5 mm per side with a tolerance of +/−0.8 mm. Alternatively, the circumferential margin can be specified as 0 mm per side with a unilateral tolerance of −1.6 mm. Thus, the circumferential margin is so slight that it is not readily noticeable to a consumer looking at a wheel assembly when the wheels are installed on a vehicle and with this margin the overlay can never be greater in diameter than the wheel outermost diameter. This results in an extremely close alignment of the overlay to the wheel that gives a consumer a visible impression that the entire overlay outboard surface 52 not only conceals the wheel 30, but actually is the wheel 30 and prevents the aesthetic problem of a visual impression that the wheel is smaller or larger than its design intent. Finally, the overlay 50 may include a paint finish, a plated finish, or no finish at all.

As mentioned above, the inboard surface 56 of the rim flange 58 of the overlay 50 is located net to the flange lip 38 of the wheel 30, and a portion of the overlay 50 is spaced away from the wheel 30 so that an adhesive/sealant bead 42 can be placed between the wheel's outboard surface 31 and the inboard surface 56 of the overlay 50. The adhesive/sealant bead 42 and the foam adhesive 40 can be utilized as a means for accommodating any tolerance variations between the overlay 50 and outboard surface 31 of the wheel 30. However, the primary purpose of the adhesive/sealant bead 42 is to secure the overlay to the wheel and prevent any relative movement resulting in squeaking or noise due to the overlay 50 rubbing against the wheel 30. Any appropriate foam adhesive 40, or combinations of adhesives, placed between the overlay 50 and the wheel 30, securely maintains the overlay 50 to the wheel 30 during the service life of the composite vehicle cladded wheel assembly 10.

The outboard surface of the flange lip 38 of the rim flange 37 of the wheel includes at least one circumferential indentation or groove(s) 80. The circumferential indentation 80 has at least three surfaces, namely, first surface 82, second surface 84, and a third surface 86. The circumferential indentation or groove 80 act as a reservoir for excess adhesive that might flow in a radially outward direction as the overlay 50 is assembled to the wheel 30. Initially, the adhesive 40 and/or sealant/adhesive 42 is selectively deposited on the outboard surface 31 of the wheel 30 in a predetermined pattern. As the overlay 50 is attached to the wheel 30, the adhesive 40 and/or sealant/adhesive 42 bead expands in a generally outward direction if the amount of adhesive/sealant 42 is not carefully controlled or due to tolerance variations not disposed at the proper position. An excess portion of adhesive could expand into the circumferential indentation 80 and be retained therein without radially squeezing out beyond the radially outermost edge of the flange lip 38 of the wheel 30. The retention of excess adhesive by the circumferential indentation 80 insures against squeeze out of adhesive at the interface of the outer edges of both the overlay 50 and the wheel 30, whereby an aesthetically clean look is achieved to supplement the visible impression that the overlay 50 is the wheel 30 and not a separate attachment of the assembly 10. The other purpose of the circumferential indentation 80 is to limit the direct surface contact between the flange lip 38 of the wheel 30 and the rim flange 58 of the overlay 50. This limited surface contact between the rim flange 58 and the flange lip 38 reduces the frictional contact between the rim flange 58 of the overlay 50 and the flange lip 38 of the wheel 30. Such reduced surface contact results in a lower risk of noise being generated due to appreciable rubbing of the overlay 50 against the wheel 30.

FIG. 4 illustrates another vehicle cladded wheel assembly 110 with a wheel 130 and an overlay 150. The wheel 130 has a traditional rim flange 137. The overlay 150 conforms to the traditional flange lip 138 of the wheel 130. The rim flange 137 radially extends in the generally axially outboard direction and terminates in a flange lip 138. The flange lip 138 has a radially outermost surface 138b defined by a radially outermost edge 138a. The flange lip 138 of the rim flange 137 of the wheel 130 is machined to a predetermined net dimension. The radially outermost lip or peripheral edge 158a of the overlay 150 is aligned with respect to the radially outermost surface 138b of the flange lip 138 of the wheel 130 so as to cover at least a major portion of the flange lip 138 and associated wheel 130. Furthermore, the composite dimensional height and width of the overlay 150 and the rim flange 137 of the wheel 130 define standardized dimensions that will meet attachment requirements for standardized wheel balance weights (not shown). The outboard surface of the flange lip 138 of the rim flange 137 includes at least one circumferential indentation or groove 180 having at least a first surface 182, a second surface 184, and a third surface 186 as shown in FIG. 3. The circumferential indentation or groove 180 serves the same purposes as discussed in the case of the preferred embodiment as shown in FIG. 3.

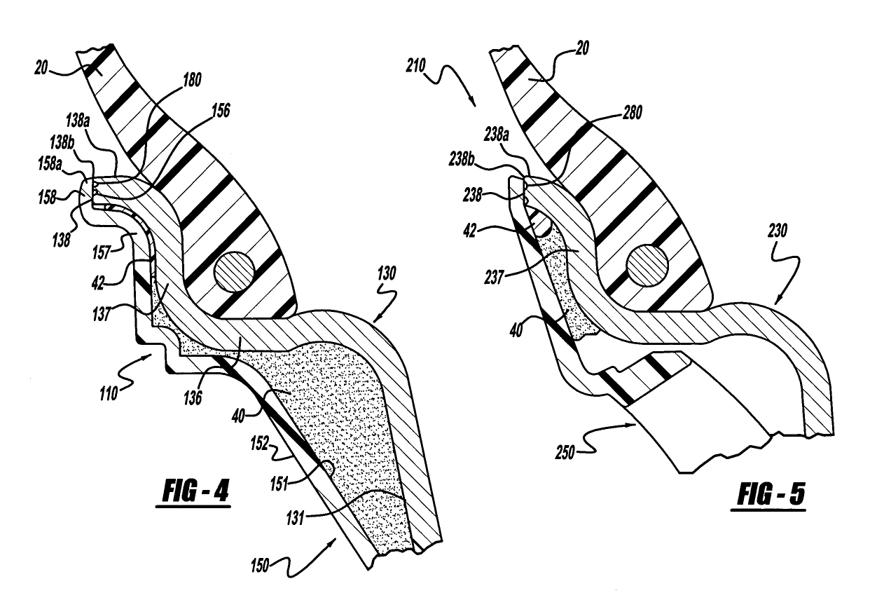

Another type of vehicle cladded wheel assembly 210 is illustrated in FIG. 5, representing a “Euro” styled look, as a variation of FIG. 3. The Euro look is typified by a shorter rim flange 237. The overlay 250 radially terminates at a radially outermost edge 238a of the rim flange 237 of the wheel 230 as well as axially net locates against the flange lip 238. The rim flange 237 extends in the generally radially outward direction, and has a radially outermost surface 238b. The outboard surface of the flange lip 238 of the rim flange 237 of the wheel includes at least one circumferential indentation 280 or groove having at least a first surface, a second surface, and a third surface (similar to that shown in FIG. 3). The circumferential indentation or groove 280 serves the same purposes as discussed in the case of the preferred embodiment. In addition to the adhesive/sealant bead 42, the foam adhesive 40 is located between the overlay 250 and the wheel 230. This configuration creates a seal such that when the foam adhesive 40 is used between the overlay 250 and the wheel 230, appropriate sealing is obtained during the time required to cure the foam adhesive 40. Other sealing arrangements are contemplated within the scope of the invention. The Euro flange is prevalent in Europe and does not accept clip or balance weights (not shown) attached to the rim flange 238 of the wheel 230. Instead, weights are generally taped to the radially inner face of the wheel 230 (not shown).

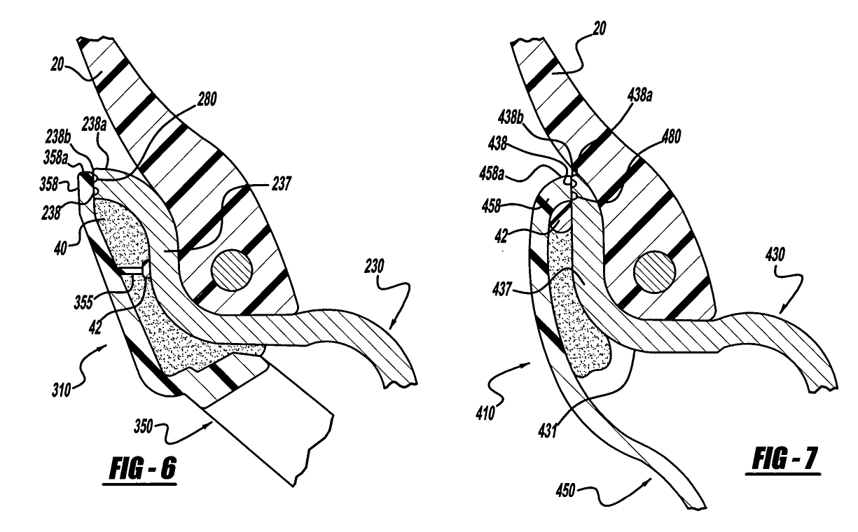

The embodiment of FIG. 6 is a cladded wheel assembly 310 that is another variation of FIG. 4, and depicts a Euro style rim flange 237 as set forth above in FIG. 5. An overlay 350 is located on the wheel 230 by an offset 355 attached to the inboard side of the overlay 350. The offset 355 spaced away from the overlay relative to the wheel 230 and adhesive/sealant bead 42 positions the offset in place on the outboard face of the wheel. As discussed previously, the overlay 350 extends radially outwardly to cover a major portion of the flange lip 238 of the wheel but does not extend beyond the radially outermost edge 238a of the wheel 230. However, any space between the overlay 350 and the flange lip 238 of the wheel 230 may be sealed by the foam adhesive 40 placed between the overlay 350 and wheel 230. The seal prevents water, dirt or mud from entering the space between the overlay 350 and the wheel 230. The rim flange 237 of the wheel extends in the generally radially and axially outward direction, and has an axially outermost surface 238b. The outboard surface of the flange lip 238 of the rim flange 237 includes at least one circumferential indentation or groove(s) 280 having at least a first surface, a second surface, and a third surface as earlier described. The circumferential indentation or groove 280 of the flange lip 238 serves the same purposes as discussed in the case of the preferred embodiment.

Another embodiment of the proposed invention of a cladded wheel assembly 410 shown in FIG. 7 illustrates a cross section of the wheel 430 similar to the newly developed Pneu Accrohage (PAV-vertically anchored tire) by Michelin, wherein the traditional axially extending portion of the rim flange and associated flange lip 438 of the wheel 430 has been modified to be eliminated. The rim flange 437 of this embodiment has no axially outboard extending flange lip 438. Rather, the rim flange 437 of this embodiment radially extends in a radially outward direction and terminates in the flange lip 438, which continues from the rim flange 437 in a generally radially outward direction. The flange lip 438 is defined by a radially outermost edge 438a and has a radially outermost surface 438b. As described above, the radially outermost lip or peripheral edge 458a of the rim flange 458 of the overlay 450 extends as far as, but no further than, the radially outermost edge 438a of the flange lip 438 of the wheel 430 so as to provide a visible impression that the decorative layer completely covers the outboard surface 431 of the wheel 430 to the outer periphery thereof without detrimental aesthetic effects. As with all of the embodiments of the present invention, it is preferable that a circumferential margin be defined between the overall diameter of the overlay 450 and the overall diameter of the wheel 430 because of the concentricity tolerance variations between the respective outer diameters of the wheel 430 and the overlay 450. The rim flange 437 extends in the generally radially outward direction, and has the radially outermost surface 438b. The outboard surface of the flange lip 438 of the rim flange 437 includes at least one circumferential indentation or groove(s) 480 having at least a first surface, a second surface, and a third surface as earlier illustrated. The circumferential indentation or groove 480 of the flange lip 438 serves the same purposes as discussed in the case of the preferred embodiment. Since the embodiment of FIG. 7 depicts a wheel 430 without the traditional flange lip, such configuration would not comply with the standard Tire and Rim Association standard dimensions as well as nomenclature.

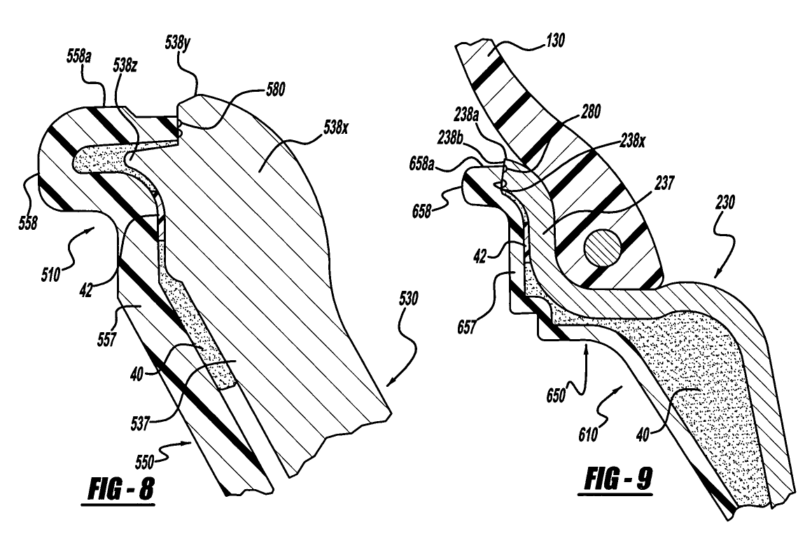

Yet, another embodiment of the proposed invention, as shown in FIG. 8, is similar to the traditional rim flange and flange lip similar to FIG. 4. FIG. 8 also illustrates a cross section of a wheel 530 wherein the traditional rim flange and flange lip of the wheel has been modified. A rim flange 537 of this embodiment does not terminate in an axially outboard extending flange lip as with prior embodiments. Rather, the rim flange 537 of this embodiment is truncated to eliminate the axially extending portion and associated flange lip 538X that is integral with the rim flange 537. The rim flange 537 has a radially outermost edge 538Y and an axial protrusion 538Z underlying the rim flange 558 of the overlay 550. Accordingly, a radially outermost lip or peripheral edge 558a of the overlay 550 extends as far as, but no further than, the radially outermost edge 538Y of the wheel flange lip 538X. This configuration provides a visible impression that the vehicle wheel cladding assembly 510 incorporates the traditional flange lip, in this case on the overlay 550 instead of the wheel 530. As in other embodiments, the decorative layer gives the visual impression that it completely covers the outboard surface 531 of the wheel 530 to the outer periphery thereof.

However, unlike the embodiment of FIG. 7, here the peripheral flange 557 of the overlay 550 is formed to simulate a wheel rim flange 537 to present the rim flange 558 of the overlay 550 in such a way as to resemble the traditional wheel rim flange lip. Consequently, a standard balance weight (not shown) may be attached entirely to the peripheral flange 557 and rim flange 558 of the overlay 550, and not attached to the traditional rim flange of the wheel. The radially outermost lip or peripheral edge 558a of the rim flange 558 is relieved at its diametrically outermost edge 575, as shown, to accommodate and retain the locking tab found on most balance weights. Additionally, the rim flange 558 of the overlay 550 net locates directly against the flange lip 538X of the wheel 530, using an adhesive/sealant bead 42 as well as an adhesive 40 to take up the tolerance variation therebetween when the cover is permanently mounted to the wheel 530. The outboard surface of the flange lip 538X of the rim flange 537 includes at least one circumferential indentation or groove(s) 580 having at least a first surface, a second surface, and a third surface as earlier described. The circumferential indentation or groove 580 of the flange lip 538X serves the same purposes as discussed in the case of the preferred embodiment.

Finally, FIG. 9 illustrates another cladded wheel assembly 610 that is a further variation on FIG. 8, wherein a rim flange 658 of an overlay 650 is formed relative to a wheel rim flange 237 in such a way so as to resemble a traditional flange lip of the rim flange 237 of a wheel 230. Consequently, a standard balance weight (not shown) may be attached only to the peripheral flange 657 and rim flange 658 of the overlay 650, and not attached to the rim flange 237 and/or flange lip 238X of the wheel 230. As in the previous embodiments, the flange lip 238X of the rim flange 237 of the wheel has a radially outermost edge 238a defined by a radially outermost surface 238b. Note that the adhesive 40 is disposed radially inward and outward of the sealant bead 42. Accordingly, the adhesive aids in securing the outer periphery of the overlay 650 to the outer periphery of the wheel 230 and thereby aids in distributing stress loads therebetween. The portion of the adhesive 40 that is radially outward of the sealant bead 42 can be a different type of adhesive than the portion that is radially inward of the sealant bead 42. The outboard surface of the flange lip 238X of the rim flange 237 includes at least one circumferential indentation or groove 280 having at least a first surface, a second surface, and a third surface as earlier described. The circumferential indentation or groove 280 serves the same purposes as discussed in the case of the preferred embodiment

The unique configuration of FIG. 9 has several specific advantages. First, a standard wheel balance weight can more easily be assembled to the wheel assembly 610 because the rim flange 658 of the overlay 650 is relatively narrower than the width of the rim flange 658 and flange lip 238X of the wheel and overlay combined. Second, since the axially shorter flange lip 238X of this Euro style wheel is less prominent, the axially longer rim flange 658 of the overlay 650 provides the more prominent feature of prior art wheel designs, with a cost savings and lower overall weight due to the shorter metal flange lip being replaced with plastic material. The result is an enhancement of the overall appearance of the wheel assembly since the overlay 650 more nearly resembles the wheel 230 rather than a separately attached component.

As set forth above, according to the present invention, on the outboard surface of the flange lip of the wheel there is provided, at least one circumferential indentation or groove to receive and retain excess adhesive that is used to permanently secure a wheel cover or overlay to a wheel to form a wheel and overlay assembly. The function of the circumferential indentation or groove of the flange lip of the wheel is two fold. First, it intercepts excess adhesive from radially flowing in an outward direction to reach the outer edges of the wheel and overlay assembly. The excess adhesive is then retained by the circumferential indentation assuring that, the excess adhesive will not squeeze out along the outer edges of the wheel and overlay assembly, which would otherwise necessitate a costly clean up. By eliminating such squeeze out of excess adhesive along the outer edges of the wheel and overlay assembly, the circumferential indentation or groove helps insure an aesthetically pleasing look of the wheel and overlay assembly as a whole. Second, the contoured surfaces of the circumferential indentation or groove of the flange lip of the wheel help reduce surface contact between the flange lip of the wheel and the outer peripheral flange portion of the overlay. In addition, the migrated adhesive in the circumferential indentation or groove of the flange lip will create a film of adhesive between the flange lip of the wheel and the peripheral flange portion of the overlay. Together, the reduced surface contact and the presence of a film of adhesive between the overlay and the wheel will reduce friction between the overlay and the wheel thereby avoiding excessive rubbing against the wheel. Friction between two surfaces often creates unpleasant squeaking or noises. Reducing the friction between the peripheral flange portion of the overlay and the flange lip of the wheel will substantially reduce such squeaking or noise.

The wheel and overlay assembly incorporates the overlay that is permanently secured to the outboard surface of the wheel, wherein the overlay extends radially outward to cover a major portion of the flange lip of a wheel but does not extend beyond the radially outermost edge of the flange lip of the rim flange of the wheel, such that the outer diameter of the overlay appears to be the actual wheel diameter and not a separate attachment and also to avoid any damage to the rim flange of the wheel or the outer diameter of the overlay. If as a result of process tolerance changes, excess adhesive is allowed to migrate to the outer edges of the wheel and overlay assembly, and eventually squeeze out of the edges of the assembly, a costly clean up of such squeezed out adhesive will be needed, or else, the intended aesthetically pleasing look of the wheel and overlay assembly will be marred. By providing a groove into which the excess adhesive can reside, such costly clean up of excess adhesive is prevented. The present invention insures an aesthetically clean look of the wheel and overlay assembly.

The present invention helps achieve the goal of avoiding a costly clean up of squeezed out adhesive, along the outer edges of a wheel and overlay assembly, by intercepting and containing the excess adhesive from flowing toward the outer edges of the wheel and overlay assembly. By eliminating such squeeze out of excess adhesive, the present invention also improves the overall aesthetics of the wheel and overlay assembly. In addition, the present invention reduces the frictional squeaking or noise that results from the overlay rubbing against the outboard surface of the wheel.

The present invention not only avoids costly cleanups of excess adhesive by the use of the circumferential indentation or grooves in the flange lip of the wheel resulting in improving the overall aesthetics of the wheel and overlay assembly; it also reduces frictional contact between the wheel cover or overlay and the wheel avoiding squeaking or noise during a normal operation of an automobile.

While the invention has been described in terms of a preferred embodiment, it is apparent that other forms could be adopted by one skilled in the art. Accordingly, the scope of the invention is to be limited only by the following claims.

What is claimed is:

1. A wheel and overlay assembly comprising:
a wheel having an outboard surface, said wheel further having a disk portion and a rim portion circumscribing said disk portion, said rim portion having a rim flange circumscribing said rim portion, said rim flange terminating in a flange lip defining a radially outermost edge, said flange lip having an outboard surface;
an overlay having an outboard surface, said overlay being attached to said outboard surface of said wheel, said overlay further having a web portion, and a peripheral flange circumscribing said web portion and terminating in a rim flange, said rim flange having a radially outermost lip aligned within a predetermined margin of said radially outermost edge of said flange lip of said wheel such that said rim flange of said overlay does not radially extend beyond said outermost edge of said flange lip of said wheel regardless of tolerance variations of said overlay and said wheel, whereby said overlay gives a visible impression that said outboard surface of said overlay is actually said outboard surface of said wheel and not a separately attached component of said wheel and overlay assembly;
an adhesive deposited between said overlay and said outboard surface of said wheel, said adhesive attaching said overlay to said outboard surface of said wheel;
means for receiving excess adhesive deposited between said overlay and said outboard surface of said wheel, said means for receiving said adhesive located on said outboard surface of said flange lip of said wheel, whereby as said overlay is attached to said wheel said receiving means receives excess adhesive squeezed out between said overlay and said wheel; and
said means for receiving excess adhesive further comprising means for reducing surface contact between said flange lip of said wheel and said rim flange of said overlay, whereby as said overlay is attached to said wheel only limited surface contact occurs between said overlay and said wheel.

2. The wheel and overlay assembly of claim 1, wherein said radially outermost lip of said rim flange of said overlay is aligned with said radially outermost edge of said flange lip of said wheel within a circumferential margin of about 1.2 to 1.5 millimeters having a bilateral tolerance of about 0.8 millimeter.

3. The wheel and overlay assembly of claim 2, wherein said radially outermost lip of said rim flange of said overlay is aligned with said radially outermost edge of said flange lip of said wheel further within a circumferential margin of 0 millimeter having a unilateral tolerance of about 1.6 millimeters.

4. The wheel and overlay assembly of claim 1, wherein said means for receiving excess adhesive comprising at least one circumferential indentation formed on said outboard surface of said flange lip of said wheel.

5. The wheel and overlay assembly of claim 4, wherein said at least one circumferential indentation further defines at least a first surface, a second surface, and a third surface.

6. The wheel and overlay assembly of claim 1, wherein at least a portion of said overlay is spaced away from said outboard surface of said wheel by an adhesive/sealant bead means.

7. The wheel and overlay assembly of claim 4, wherein said adhesive is selectively deposited on said outboard surface of said wheel in a predetermined pattern such that no adhesive flows into said at least one circumferential indentation of said flange lip of said wheel prior to said overlay is attached to said outboard surface of said wheel.

8. The wheel and overlay assembly of claim 1, wherein said overlay further comprising:
an inboard surface; and
at least one offset integral with said inboard surface of said overlay, said at least one offset locating said overlay relative to said rim flange of said wheel.

9. The wheel and overlay assembly of claim 1, wherein said adhesive is an adhesive means.

10. The wheel and overlay assembly of claim 1, wherein said overlay includes a heat-resistant metal-plated finish.

11. The wheel and overlay assembly of claim 1, wherein said overlay includes a heat-resistant paint finish.

12. The wheel and overlay assembly of claim 1, wherein said overlay includes a weatherable material with no finish applied thereto.

13. The wheel and overlay assembly of claim 1, wherein said wheel is composed of a metal material.

14. A wheel and overlay assembly comprising:
a wheel having an outboard surface, said wheel further having a disk portion and a rim portion circumscribing said disk portion, said rim portion having a rim flange circumscribing said rim portion, said rim flange terminating in a flange lip defining a radially outermost edge, said radially outermost edge defining a radially outermost diameter, said flange lip having an outboard surface;
an overlay having an outboard surface, said overlay being attached to said outboard surface of said wheel, said overlay further having a web portion and a peripheral flange circumscribing said web portion and terminating in a rim flange, said rim flange of said overlay having an inboard surface portion located net against said outboard surface of said flange lip of said wheel, said rim flange of said overlay further having a radially outermost lip defining a radially outermost diameter, said diameter of said overlay being within a predetermined margin less than said radially outermost diameter of said wheel such that said rim flange of said overlay does not radially extend beyond said radially outermost edge of said flange lip of said wheel regardless of tolerance variations of said overlay and said wheel, whereby said overlay gives a visible impression that said outboard surface of said overlay is actually said outboard surface of said wheel and not a separately attached component of said wheel and overlay assembly;
an adhesive deposited between said overlay and said outboard surface of said wheel, said adhesive attaching said overlay to said outboard surface of said wheel;
means for receiving excess adhesive deposited between said overlay and said outboard surface of said wheel, said means for receiving said adhesive located on said outboard surface of said flange lip of said wheel, whereby as said overlay is attached to said wheel said receiving means receives excess adhesive squeezed out between said overlay and said wheel; and
said means for receiving excess adhesive further comprising means for reducing surface contact between said flange lip of said wheel and said rim flange of said overlay, whereby as said overlay is attached to said wheel only limited surface contact occurs between said overlay and said wheel.

15. The wheel and overlay assembly of claim 14, wherein said radially outermost diameter of said overlay is substantially equal to said radially outermost diameter of said wheel within a circumferential margin therebetween of about 1.2 to 1.5 millimeters having a bilateral tolerance of about 0.8 millimeter.

16. The wheel and overlay assembly of claim 15, wherein said radially outermost diameter of said overlay is substantially equal to said radially outermost diameter of said wheel further within a circumferential margin therebetween of 0 millimeters having a unilateral tolerance of about 1.6 millimeter.

17. The wheel and overlay assembly of claim 14, wherein said means for receiving excess adhesive comprising at least one circumferential indentation formed on said outboard surface of said flange lip of said wheel.

18. The wheel and overlay assembly of claim 17, wherein said at least one circumferential indentation further defines at least a first surface, a second surface, and a third surface.

19. The wheel and overlay assembly of claim 14, wherein at least a portion of said cover is spaced away from said outboard surface of said wheel by an adhesive/sealant bead means.

20. The wheel and overlay assembly of claim 17, wherein said adhesive is selectively deposited on said outboard surface of said wheel in a predetermined pattern such that no adhesive flows into said at least one circumferential indentation of said flange lip of said wheel prior to said overlay is attached to said outboard surface of said wheel.

21. The wheel and overlay assembly of claim 14, wherein said overlay further comprising:
an inboard surface; and
at least one offset integral with said inboard surface of said overlay, said at least one offset locating said overlay relative to said rim flange of said wheel.

22. The wheel and overlay assembly of claim 14, wherein said adhesive is an adhesive means.

23. The wheel and overlay assembly of claim 14, wherein said overlay includes a heat-resistant metal-plated finish.

24. The wheel and overlay assembly of claim 14, wherein said overlay includes a heat-resistant paint finish.

25. The wheel and overlay assembly of claim 14, wherein said overlay includes a weatherable material with no finish applied thereto.

26. The wheel and overlay assembly of claim 14, wherein said wheel is composed of a metal material.
